(19) United States
(12) Patent Application Publication
(10) Pub. No.: US 2013/0159673 A1
(43) Pub. Date: Jun. 20, 2013

(54) PROVIDING CAPACITY GUARANTEES FOR HARDWARE TRANSACTIONAL MEMORY SYSTEMS USING FENCES

(71) Applicants: Martin T. Pohlack, Dresden (DE); Michael Hohmuth, Dresden (DE); Stephan Diestelhorst, Dresden (DE); David Christie, Austin, TX (US); Luke Yen, Ayer, MA (US)

(72) Inventors: Martin T. Pohlack, Dresden (DE); Michael Hohmuth, Dresden (DE); Stephan Diestelhorst, Dresden (DE); David Christie, Austin, TX (US); Luke Yen, Ayer, MA (US)

(73) Assignee: Advanced Micro Devices, Inc.

(21) Appl. No.: 13/327,657

(22) Filed: Dec. 15, 2011

(51) Int. Cl. G06F 9/30; G06F 9/38

(52) U.S. Cl. 712/208; 712/220; 712/E09.016; 712/E09.028; 712/E09.045

(57) ABSTRACT

A method is provided that includes determining a number of outstanding out-of-order instructions in an instruction stream. The method includes determining a number of available hardware resources for executing out-of-order instructions and inserting fencing instructions into the instruction stream if the number of outstanding out-of-order instructions exceeds the determined number of available hardware resources. A second method is provided for compiling source code that includes determining a speculative region. The second method includes generating machine-level instructions and inserting fencing instructions into the machine-level instructions in response to determining the speculative region. A processing device is provided that includes cache memory and a processing unit to execute processing device instructions in an instruction stream. The processing device includes an out-of-order speculation supervisor unit to determine hardware resource availability and generate an indication to insert fencing instructions in response to the availability. Computer readable storage media are also provided.

### BACKGROUND

1. Field of the Invention

Embodiments presented herein relate generally to computing systems, and, more particularly, to a method for managing out-of-order instruction speculation.

2. Description of Related Art

Electrical circuits and devices that execute instructions and process data have evolved becoming faster, larger and more complex. With the increased speed, size, and complexity of electrical circuits and data processors, the synchronization of instruction streams and system data has become more problematic, particularly in out-of-order systems and/or pipe-lined systems. As technologies for electrical circuits and processing devices have progressed, there has developed a greater need for efficiency, reliability and stability, particularly in the area of instruction/data synchronization. However, considerations for processing speeds, overall system performance, the area and/or layout of circuitry, as well as system complexity introduce substantial barriers to efficiently processing data in a transactional computing system. The areas of data coherency, hardware capacity and efficient use of processor cycles are particularly problematic, for example, in multi-processor or multi-core processor implementations.

Typically, modern implementations for managing hardware capacity and processor cycle issues in out-of-order systems, as noted above, have taken several approaches: system transactions may be aborted/retried, software may be used to supplement processor architecture, or system hardware capacities may be increased, for example, by using larger caches or additional buffering. However, each of these approaches has undesirable drawbacks. Aborting and/or retrying transactions greatly effects system performance. Transactions that are aborted or retried require additional time and system resources to complete. Supplementing hardware architectures with software solutions are cumbersome, slowing down the system, and are awkward from an implementation perspective resulting in additional processor complexity. Increasing system hardware, such as larger caches or additional buffering, increases system costs, creates size and power constraints, and adds overall system complexity.

Embodiments presented herein eliminate or alleviate the problems inherent in the state of the art described above.

### SUMMARY OF EMBODIMENTS

In one aspect of the present invention, a method is provided. The method includes determining a number of outstanding out-of-order instructions in an instruction stream to be executed by a processing device and determining a number of hardware resources available for executing out-of-order instructions. The method also includes inserting at least one fencing instruction into the instruction stream in response to determining the number of outstanding out-of-order instructions exceeds the determined number of available hardware resources.

In another aspect of the invention, a method is provided. The method includes compiling a portion of source code. Compiling the source code includes determining a speculative region associated with the portion of source code, generating a plurality of machine-level instructions based at least on the portion of source code and inserting at least one fencing instruction into the plurality of machine-level instructions in response to determining the speculative region.

In yet another aspect of the invention, a processing device is provided. The processing device includes at least one cache memory and at least one processing unit, communicatively coupled to the at least one cache memory, being adapted to execute one or more processing device instructions in an instruction stream. The processing device also includes an out-of-order speculation supervisor unit adapted to determine an availability of at least one hardware resource associated with the processing device, and adapted to generate an indication to insert a fencing instruction in response to the determined availability.

In still another aspect of the invention, a computer readable storage device encoded with data that, when implemented in a manufacturing facility, adapts the manufacturing facility to create an apparatus is provided. The apparatus includes at least one cache memory and at least one processing unit, communicatively coupled to the at least one cache memory, being adapted to execute one or more processing device instructions in an instruction stream. The processing device also includes an out-of-order speculation supervisor unit adapted to determine an availability of at least one hardware resource associated with the processing device, and adapted to generate an indication to insert a fencing instruction in response to the determined availability.

In still another aspect of the invention, a non-transitory, computer-readable storage device encoded with data that, when executed by a processing device, adapts the processing device to perform a method, is provided. The method includes determining a number of outstanding out-of-order instructions in an instruction stream to be executed by a processing device and determining a number of hardware resources available for executing out-of-order instructions. The method also includes inserting at least one fencing instruction into the instruction stream in response to determining the number of outstanding out-of-order instructions exceeds the determined number of available hardware resources.

In still another aspect of the invention, a non-transitory, computer-readable storage device encoded with data that, when executed by a processing device, adapts the processing device to perform a method, is provided. The method includes compiling a portion of source code. Compiling the source code includes determining a speculative region associated with the portion of source code, generating a plurality of machine-level instructions based at least on the portion of source code and inserting at least one fencing instruction into the plurality of machine-level instructions in response to determining the speculative region.

### BRIEF DESCRIPTION OF THE DRAWINGS

The embodiments herein may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates a simplified block diagram of a computer system including one or more processing devices with cache and speculation circuitry, according to one embodiment;

FIG. 2 shows a simplified block diagram of a CPU that includes a cache and speculation circuit, according to one embodiment;

FIG. 3A provides a representation of a silicon die/chip that includes one or more CPUs, according to one embodiment;

FIG. 3B provides a representation of a silicon wafer which includes one or more die/chips that may be produced in a fabrication facility, according to one embodiment;

FIG. 4 illustrates a schematic diagram of a portion of a computer with a CPU and a compiler as provided in FIGS. 1-3B, according to one embodiment;

FIG. 5 illustrates a schematic diagram of a portion of the CPU as provided in FIGS. 1-4, according to one embodiment;

FIG. 6 illustrates a schematic diagram of a portion of the CPU as provided in FIGS. 1-5, according to one embodiment;

FIG. 7 illustrates a flowchart depicting managing of hardware capacity guarantees using fences, according to one exemplary embodiment; and

FIG. 8 illustrates a flowchart depicting managing of hardware capacity guarantees using fences, according to one exemplary embodiment.

While the embodiments herein are susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the scope of the invention as defined by the appended claims.

### DETAILED DESCRIPTION

Illustrative embodiments of the instant application are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and/or business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present application will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present embodiments. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As used herein, the terms “substantially” and “approximately” may mean within 85%, 90%, 95%, 98% and/or 99%. In some cases, as would be understood by a person of ordinary skill in the art, the terms “substantially” and “approximately” may indicate that differences, while perceptible, may be negligent or be small enough to be ignored. Additionally, the term “approximately,” when used in the context of one value being approximately equal to another, may mean that the values are “about” equal to each other. For example, when measured, the values may be close enough to be determined as equal by one of ordinary skill in the art.

Embodiments presented herein relate to managing out-of-order (OOO) instruction speculation. In various embodiments, this management is performed using one or more specific Advanced Synchronization Facilities (ASFs), that build upon the general ASF proposal set forth in the “Advanced Synchronization Facility Proposed Architectural Specification” presented by AMD (March 2009, available at http://developer.amd.com/tools/ASF/Pages/default.aspx), incorporated herein by reference, in its entirety.

One issue with OOO speculation in modern processors is that additional resources may be required for instructions that are currently being executed speculatively (e.g., OOO instructions. One aspect of ASF may aim to provide a minimal guarantee of, for example, four available cache lines in a processor system. Such a guarantee may simplify the development of software on top of the ASF. A guarantee of four lines may provide industry-wide applicability, as this is a typical associativity for a level 1 (L1) cache in modern micro-processors. Some embodiments presented herein may implement various ASF schemes to selectively limit the OOO speculation in some situations such that over-provisioning is no longer required or can be easily bounded to a reasonable and/or typical amount of resources. In one or more embodiments described herein, OOO speculation may be limited to less than four lines or more than four lines or, in some cases, the OOO speculation may not be limited. It should be noted, however, that one or more restrictions on the OOO speculation may be altered before or during compilation, or afterward at runtime, for example.

Such limiting may be achieved by using a fencing mechanism (or fences) between specific instructions to be executed by a processor. Fences act as a barrier to OOO speculation and may take various forms. Fences may be implemented as a full machine instruction exposed at the ISA level (similarly to load and store fences). Fences may also be implemented in the form of new micro-instructions (micro-operations) that act as barriers in the processor. Fencing may also be achieved by marking other machine instructions or micro-instructions as “fencing”. That is, an instruction that is not a fencing instruction may be tagged or modified to act as a fence. The actual form of the fence mechanism used herein is not to be considered limiting or essential to the function of any particular embodiments. As referred to herein, the term fence may be used to refer to the mechanism of fencing independently of the actual implementation of various embodiments. In various embodiments, fences and fencing mechanisms may be implemented in a microprocessor (e.g., CPU 140 described below), a graphics processor (e.g., a GPU 125 described below) and/or a compiler.

As shown in the Figures and as described below, the embodiments described herein show a novel design and method that efficiently solves this OOO speculation problem described above. For example, one purpose of fences, as described in relation to the various embodiments presented herein, is to limit the amount of OOO speculation (e.g., OOO instructions in flight in a processor) and thereby limit the amount of additional resources necessary to provide ASF guarantees. For an ASF implementation, where critical resources are used up by speculative stores and loads, fences may take the form of a serializing barrier to those instructions (e.g., LOCK MOV, LOCK PREFETCH, and LOCK PREFETCHW). A compiler or CPU (e.g., compiler 410 and/or CPU 140 described below), may insert a fence after every fourth such instruction, for example, in a static fashion in the compiled binary code and/or the CPU micro-instructions for speculative regions of a program. If hardware resources begin to fill up (or are already filled up) during the execution of the program, fences may be inserted at smaller intervals (e.g., every second instruction) to account for this decrease in hardware capacity availability.

Providing hardware capacity guarantees is beneficial from a software point of view at least because software and software resources may not be needed to provide for fallback paths in the event an OOO speculation overflow condition occurs. Similarly, providing hardware capacity guarantees is also beneficial from a hardware point of view at least because expensive over-provisioning of hardware resources may not be necessary.

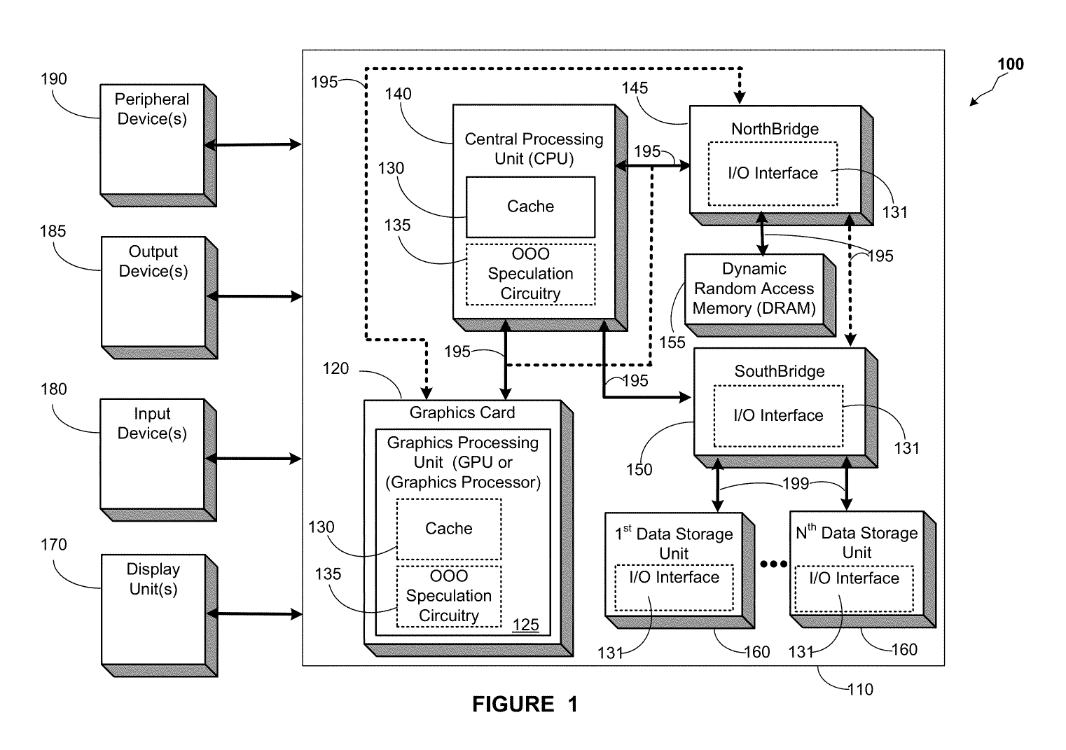

Turning now to FIG. 1, a block diagram of an exemplary computer system 100, in accordance with an embodiment of the present application, is illustrated. In various embodiments the computer system 100 may be a personal computer, a laptop computer, a handheld computer, a tablet computer, a mobile device, a telephone, a personal data assistant (“PDA”), a server, a mainframe, a work terminal, a music player, and/or the like. The computer system includes a main structure 110 which may be a computer motherboard, circuit board or printed circuit board, a desktop computer enclosure and/or tower, a laptop computer base, a server enclosure, part of a mobile device, personal digital assistant (PDA), or the like. In one embodiment, the main structure 110 includes a graphics card 120. In one embodiment, the graphics card 120 may be a Radeon™ graphics card from Advanced Micro Devices (“AMD”) or any other graphics card using memory, in alternate embodiments. The graphics card 120 may, in different embodiments, be connected on a Peripheral Component Interconnect “(PCI”) Bus (not shown), PCI-Express Bus (not shown) an Accelerated Graphics Port (“AGP”) Bus (also not shown), or any other computer system connection. It should be noted that embodiments of the present application are not limited by the connectivity of the graphics card 120 to the main computer structure 110. In one embodiment, the computer system 100 runs an operating system such as Linux, UNIX, Windows, Mac OS, or the like. In various embodiments, the computer system 100 includes a compiler (e.g., compiler 410, described below) that runs on an operating system platform and is capable of compiling source code, generating binary code (machine-level code), and/or the like. The compiler is discussed in further detail below.

In one embodiment, the graphics card 120 may contain a processing device such as a graphics processing unit (GPU) 125 used in processing graphics data. The GPU 125, in one embodiment, may include one or more embedded memories, such as one or more caches 130. The GPU caches 130 may be L1, L2, higher level, graphics specific/related, instruction, data and/or the like. In various embodiments, the embedded memory(ies) may be an embedded random access memory (“RAM”), an embedded static random access memory (“SRAM”), or an embedded dynamic random access memory (“DRAM”). In alternate embodiments, the embedded memory(ies) may be embedded in the graphics card 120 in addition to, or instead of, being embedded in the GPU 125. In various embodiments the graphics card 120 may be referred to as a circuit board or a printed circuit board or a daughter card or the like.

In one embodiment, the computer system 100 includes a processing device such as a central processing unit (“CPU”) 140, which may be connected to a northbridge 145. In various embodiments, the CPU 140 may be a single- or multi-core processor, or may be a combination of one or more CPU cores and a GPU core on a single die/chip (such an AMD Fusion™ APU device). In one embodiment, the CPU 140 may include one or more cache memories 130, such as, but not limited to, L1, L2, level 3 or higher, data, instruction and/or other cache types. In one or more embodiments, the CPU 140 may be a pipe-lined processor. In one or more embodiments, the CPU 140 may include OOO speculation circuitry 135 that may comprise fence generating circuitry (e.g., circuitry to generate fencing instructions and/or modify pre-existing instructions to act as fences) and/or OOO speculation monitoring circuitry (e.g., circuitry to monitor system states, hardware capacity availability, CPU 140 pipeline status, fencing instructions and/or to generate various models as described herein). In various embodiments, the GPU 125 may include the may include OOO speculation circuitry 135, as described above. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other computer system connection. For example, CPU 140, northbridge 145, GPU 125 may be included in a single package or as part of a single die or “chips” (not shown). Alternative embodiments which alter the arrangement of various components illustrated as forming part of main structure 110 are also contemplated. In certain embodiments, the northbridge 145 may be coupled to a system RAM (or DRAM) 155; in other embodiments, the system RAM 155 may be coupled directly to the CPU 140. The system RAM 155 may be of any RAM type known in the art; the type of RAM 155 does not limit the embodiments of the present application. In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In one embodiment, the southbridge 150 may have one or more I/O interfaces 131, in addition to any other I/O interfaces 131 elsewhere in the computer system 100. In various embodiments, the southbridge 150 may be connected to one or more data storage units 160 using a data connection or bus 199. The data storage units 160 may be hard drives, solid state drives, magnetic tape, or any other writable media used for storing data. In one embodiment, one or more of the data storage units may be USB storage units and the data connection 199 may be a USB bus/connection. Additionally, the data storage units 160 may contain one or more I/O interfaces 131. In various embodiments, the central processing unit 140, northbridge 145, southbridge 150, graphics processing unit 125, DRAM 155 and/or embedded RAM may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195.

In different embodiments, the computer system 100 may be connected to one or more display units 170, input devices 180, output devices 185 and/or other peripheral devices 190. It is contemplated that in various embodiments, these elements may be internal or external to the computer system 100, and may be wired or wirelessly connected, without affecting the scope of the embodiments of the present application. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier or other output device. The peripheral devices 190 may be any other device which can be coupled to a computer: a CD/DVD drive capable of reading and/or writing to corresponding physical digital media, a universal serial bus (“USB”) device, Zip Drive, external floppy drive, external hard drive, phone and/or broadband modem, router/gateway, access point and/or the like. The input, output, display and peripheral devices/units described herein may have USB connections in some embodiments. To the extent certain exemplary aspects of the computer system 100 are not described herein, such exemplary aspects may or may not be included in various embodiments without limiting the spirit and scope of the embodiments of the present application as would be understood by one of skill in the art.

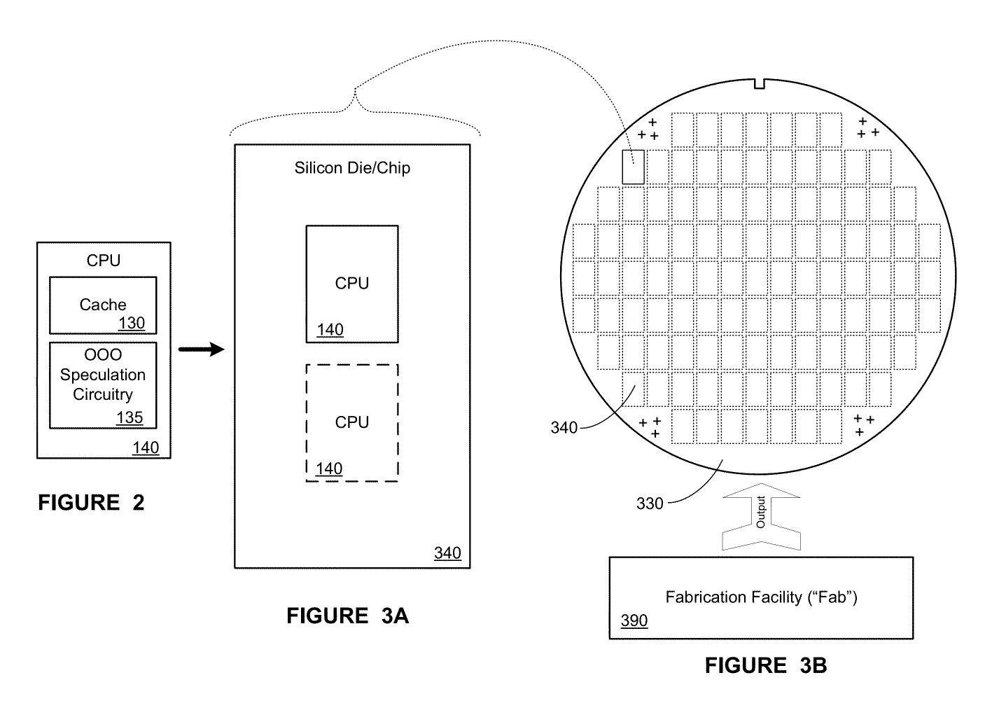

Turning now to FIG. 2, a block diagram of an exemplary CPU 140, in accordance with an embodiment of the present application, is illustrated. In one embodiment, the CPU 140 may contain one or more cache memories 130. The CPU 140, in one embodiment, may include L1, L2 or other level cache memories 130. To the extent certain exemplary aspects of the CPU 140 and/or one or more cache memories 130 not described herein, such exemplary aspects may or may not be included in various embodiments without limiting the spirit and scope of the embodiments of the present application as would be understood by one of skill in the art. For example, CPU 140 and/or one or more cache memories 130 may be adapted to perform and/or execute instructions/transactions in a manner that may guarantee hardware capacity constraints are followed, for example, through the use of fences.

Turning now to FIG. 3A, in one embodiment, the CPU(s) 140 and the cache(s) 130 may reside on a silicon chips/die 340 and/or in the computer system 100 components such as those depicted in FIG. 1. The silicon chip(s) 340 may be housed on the motherboard (not shown) or other structure of the computer system 100. In one or more embodiments, there may be more than one CPU 140 and/or cache memory 130 on each silicon chip/die 340. As discussed above, various embodiments of the CPUs 140 may be used in a wide variety of electronic devices.

Turning now to FIG. 3B in accordance with one embodiment, and as described above, one or more of the CPUs 140 may be included on the silicon die/chips 340 (or computer chip). The silicon die/chips 340 may contain one or more CPUs 140 that may include one or more caches 130 and/or OOO speculation circuitry 135. The silicon chips 340 may be produced on a silicon wafer 330 in a fabrication facility (or “fab”) 390. That is, the silicon wafers 330 and the silicon die/chips 340 may be referred to as the output, or product of, the fab 390. The silicon die/chips 340 may be used in electronic devices, such as those described above in this disclosure.

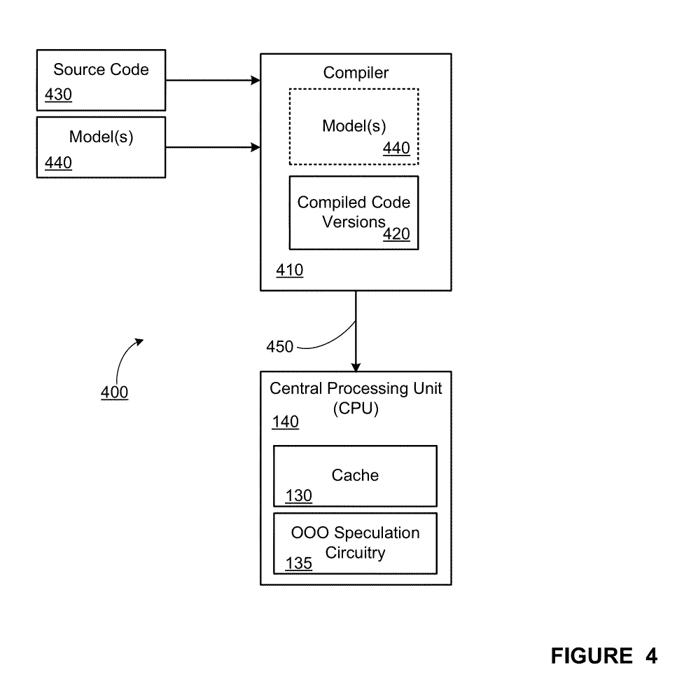

Turning now to FIG. 4, simplified schematic diagram of an exemplary embodiment of the computer 100 is shown. As shown in FIG. 4, the exemplary computer system 400 may include a CPU 140 as described above with respect to FIGS. 1-3B. That is, the CPU 140 may include one or more caches 130 and/or OOO speculation circuitry 135. The computer system 400 may also include a compiler 410 that is adapted to compile one or more source code programs 430 that may be stored on the computer system 410 (e.g., in a RAM 155, a cache 130, or a data storage unit 160) or stored in an external storage location, such as a peripheral storage device 190 or on a network (not shown). The source code programs 430 may be written in various computer languages and may comprise entire programs, program portions/segments, procedures, functions, data structures, arrays, variables, scripts and/or the like. The compiler 410 is also adapted to generate binary instructions based on the compiling of the one or more source code programs 430.

In one or more embodiments, fences and fencing mechanisms could be generated and/or implemented at the compiler level because the compiler 410 is adapted to analyze the generated code regarding the minimal hardware guarantees of ASF. Using the compiler 410 to generate and/or implement fences may allow fences to be selectively inserted accordingly for cases where a hardware guarantee is actually required, in one or more embodiments. For example, a programmer or other code generator, such as an automated code generator, may indicate at the source language level (e.g., in one or more source code programs 430), whether particular guarantees are desired for a specific block of a source code program 430. In various embodiments, the programmer or code generator may be able to determine a trade-off between average throughput against worst-case hardware guarantees. For compilers to use this approach fences need to be visible at ISA level. In one or more embodiments herein, the compiler 410 is adapted to use such fences.

The compiler 410 may use a model 440 of processor 140 operation, based upon the source code 430 and/or compiled code versions 420 at runtime to optimize the fencing mechanisms. The more sophisticated the model 440, the more aggressively optimized the fencing may be. The model(s) 440 may or may not be fully determinable at compile time, but partial model solutions (e.g., model(s) 440) may also allow fencing mechanism benefits to be realized. In one or more embodiments, the compiler 410 may be adapted to implement fencing mechanisms in a more sophisticated manner than simply providing the minimum hardware availability guarantees by using system models (440) and/or system information. For example, the compiler 410 may know or model the relative offset(s) of one or more local variables in a function, procedure or a set of recursively called functions/procedures associated with the source code 430. Similarly, the compiler 410 may know or model memory access address alignment information associated with the different functions/procedures. In one embodiment, the compiler 410 may know or model one or more of the relative addresses for accesses to large objects or data-structures associated with the source code 430. In other embodiments, the compiler 410 may know or model accesses to array indices used in source code 430 program loops and/or the like; in such cases, the modeling of these accesses may be predicted to more aggressively model and/or optimize the system performance and/or fencing mechanisms.

In one embodiment, the compiler 410 may have or generate a model(s) 440 of the hardware limitations of the processor 140 and/or the computer system 400 (e.g., minimum hardware capacity, maximum hardware capacity, cache 130 associativity limitations, and/or the like). The compiler 410 may use such model(s) 440, in addition to or independently of the models 440 described above, to insert fences selectively insert fences when hardware capacity becomes limited, more limited, or falls below a pre-defined criteria and/or value. The compiler 410 may also use such model(s) 440, in addition to or independently of the models 440 described above, to maintain a desired level of hardware capacity availability such as four lines, eight lines or twelve lines of a cache 130, or any other desired hardware capacity availability.

In one embodiment, the compiler 410 may always initially optimize to accommodate a minimal guarantee (e.g., four lines of a cache 130) in order to provide for across multiple hardware platforms. Such an approach may allow for future changes in the microarchitecture without risking over-speculation due to OOO instructions. Additionally or alternatively, the compiler 410 may, in some embodiments, optimize fencing mechanisms for a specific micro-architecture but provide a minimal guarantee as a fallback code version (e.g., code versions 420). The computer system 400 and/or the processor 140 may switch to the minimal guarantee code version 420 dynamically at runtime. Such a switch may take place when seeing capacity problems after executing a test run and/or after determining the current system's actual capabilities/performance.

In different embodiments, several code variants in the binary instructions (e.g., compiled code versions 420) may be compiled and/or stored and chosen at runtime. For example, the compiler 410 may start with a very optimistic approach (i.e., very few fencing instructions are inserted) and may switch to more conservative version(s) of the code after receiving negative feedback at runtime relating to the hardware capacity availability of the computer system 400 and/or the processor 140. Additionally or alternatively, the current hardware's capabilities may be determined at runtime and an appropriate, corresponding code path may be chosen in response from the compiled code versions 420. That is, more aggressive fence insertion may be performed using one compiled code version 420, or less aggressive fence insertion may be performed using another compiled code version 420. It is contemplated that different compiled code versions 420 may comprise code portions associated with one or more regions of the source code that are identified as speculative regions, and as such, the various compiled code versions 420 may be chosen on-the-fly.

In one embodiment, an optimization for the compiler 410 may be implemented to not initially issue fences. In such an optimistic approach, a switch to a pessimist mode, where fences are actually generated in accordance with the embodiments described herein, where the compiler 410 may generate multiple compiled code versions 420 of the speculative regions, with increasing densities of fencing instructions. In such embodiments, software may execute different variants of the code versions 420, based on runtime information gathered about a current system (e.g., computer system 100/400), and based on abort statistics for a particular speculative region of the source code 430.

It is noted that in the above mentioned embodiments, where a compiler 410 chooses between code variants and/or different code paths at runtime (e.g., compiled code versions 420), techniques such as runtime code patching, recompilation, and/or just-in-time compilation are applicable.

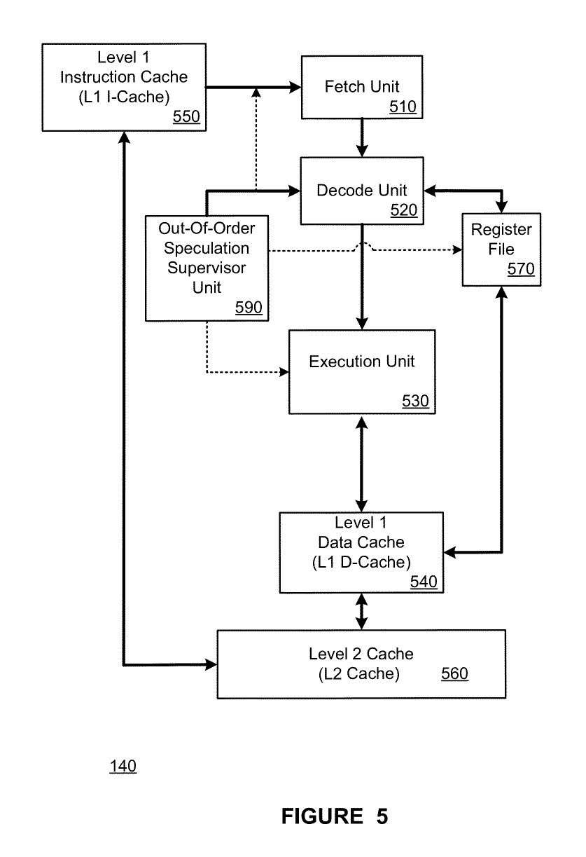

Turning now to FIG. 5, a simplified schematic diagram of an exemplary embodiment of the CPU 140 is shown. The CPU 140 may include a fetch unit 510 adapted to fetch instruction from a level 1 (L1) instruction cache 550. The fetch unit 510 may transmit one or more fetched instructions to a decode unit 520. The decode unit 520 may decode the fetched instructions and provide the decoded instruction to an execution unit 530. The execution unit 530 may be adapted to execute the decoded instruction in one or more embodiments. The execution unit may write an executed result to the level 1 (L1) data cache 540. The L1 data cache 540 and the L1 instruction cache 550 may be connected to a level 2 (L2) cache 560. In one embodiment, a register file 570 may be connected to the decode unit 520 and/or to the L1 data cache 540. The CPU 140 may also include an out-of-order (OOO) speculation unit 590 in one or more embodiments. The OOO speculation supervisor 590 may include the OOO speculation circuitry 135, as described above with respect to CPU 140. The OOO speculation supervisor 590 may be connected to the decode unit 520. In other embodiments, the OOO speculation supervisor unit 590 may be also, or alternatively, connected to the fetch unit 510, the register file 570 and/or the execution unit 530. As previously described, fences may also be generated by a processor, CPU 140, GPU 125 (for example, at the decoding or issuing pipeline stage) on-the-fly. One advantage of a processor-specific implementation may be that the OOO speculation analysis may be simpler, as the actual instruction stream may be seen at runtime. That is, costly analysis in the compiler may not be required. For such an approach, the processor may receive an indication whether hardware capacity guarantees are currently desired or not, or whether hardware capacity guarantees are in jeopardy. This may, for example, take the form of a special version of the SPECULATE instruction. In the case where hardware capacity guarantees may or may not be desired, the fence creation/insertion logic may only be active for those code segments where fencing insertion is actually desired; in cases where hardware guarantees are in jeopardy, the fence creation/insertion logic may actively insert fencing instructions to provide such guarantees. That is, a processor (e.g., GPU 125 and/or CPU 140) may observe the actual instruction stream at runtime and may insert additional fences in the form of micro-instructions, for example, after every fourth such instruction when no resources are currently in use. As such, a hardware capacity guarantee of four may be provided. If at some point during runtime only two resources are available, the processor may only allow two additional OOO speculation instructions at-a-time by issuing fences every two such instructions.

The OOO speculation supervisor unit 590 may include, in one or more embodiments, circuitry adapted to determine the availability/capacity of one or more hardware resources associated with the CPU 140. The OOO speculation supervisor unit 590 may include, in one or more embodiments, circuitry adapted to generate an indication to insert a fencing instruction in response to the determined hardware availability/capacity. For example, the OOO speculation supervisor unit 590 may monitor the capacity of one or more caches 130 (e.g., caches 540, 550, 560 and/or the like) and may provide an indication associated with the number of cache 130 lines available and/or the capacity of the caches 130.

In one embodiment, an indication may be provided from the OOO speculation supervisor unit 590 when one or more caches 130 have four cache lines available, respectively. In one embodiment, an indication may be provided from the OOO speculation supervisor unit 590 when one or more caches 130 have more or less than four cache lines available, respectively. Different levels of availability may be indicated by the OOO speculation supervisor unit 590, such as, but not limited to, two lines, eight lines, twelve lines, or another number of lines as would be determined by a designer or programmer. In one embodiment, the indication from the OOO speculation supervisor unit 590 may be transmitted to the decode unit 520 (and also, or alternatively, to the fetch unit 510, the register file 570 and/or the execution unit 530) to indicate that a fencing instruction should be inserted into the instruction stream of the CPU 140. For example, as fetched instructions are transmitted from the fetch unit 510 to the decode unit 520, the decode unit may receive an indication from the OOO speculation supervisor unit 590 that one or more caches 130 (e.g., caches 540, 550, 560 and/or the like) have four cache lines available for speculative, OOO instruction processing. This may indicate to that the CPU 140 should now limit the number of speculative, OOO instructions allowed to be in-flight because additional issuance of such instructions may overrun the hardware capacity of the CPU 140. In other words, the CPU 140 is throttled down with respect to speculative, OOO instruction issuance in order to comply with a hardware availability guarantee of four cache lines. To accomplish this guarantee, the OOO speculation supervisor unit 590 may provide indications to the decode unit 520 that indicate the decode unit 520 should insert and provide a fencing instruction, such as, but not limited to, a special fencing version of an existing instruction or a dedicated fencing instruction as described above, to the execution unit every fourth instruction cycle.

It should be noted that various units of a CPU processor, as would be known to a person of ordinary skill in the art having the benefit of this disclosure and not shown, may be included in different embodiments herein. For example, one or more scheduling units (not shown) may reside between the decode unit 520 and the one or more execution units 530. Such scheduling units may be adapted to implement scheduling of instructions for the execution unit(s) 530 in accordance with the embodiments described herein.

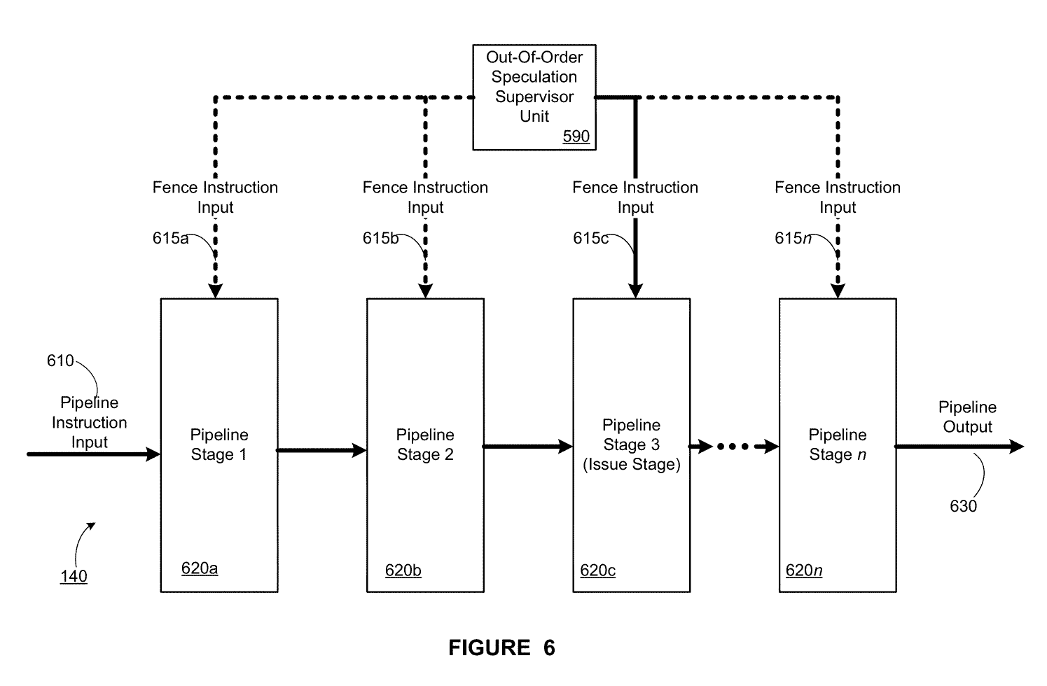

Turning now to FIG. 6, a simplified schematic diagram of an exemplary embodiment of a CPU 140 pipeline is shown. In one embodiment, the CPU 140 pipeline may include one or more pipeline stages: stage 1 620a, stage 2 620b, stage 3 620c to stage n 620n, in addition to a pipeline input 610 and a pipeline output 630. That is, any number of pipeline stages, of various types, is contemplated and may be used in accordance with the embodiments described herein. Processor instructions may proceed through the CPU 140 pipeline from stage to stage, as would be known to a person of ordinary skill in the art having the benefit of this disclosure. In various embodiments, the CPU 140 pipeline may include a fetch stage (e.g., fetch unit 510), a decode stage (e.g., decode unit 520), a scheduling stage (not shown), an execution stage (e.g., execution unit 530), and/or the like. In one embodiment, and as shown in FIG. 6, stage 3 620c may be the issue stage of the CPU 140 pipeline. As described above with respect to FIG. 5, the CPU 140 may include an OOO speculation supervisor unit 590. In one embodiment, the OOO speculation supervisor unit 590 may be connected to one or more of the pipeline stages 620a-n. In one embodiment, the OOO speculation supervisor unit 590 may be connected to the pipeline stage 3 620c in order to provide an indication that a fencing instruction should be inserted into the CPU 140 pipeline. In one or more embodiments, the OOO speculation supervisor unit 590 may provide an indication that a fencing instruction should be inserted to additionally connected pipeline stages (e.g., 620a-n). The insertion of fencing instructions may be performed similarly as described above with respect to FIG. 5.

In one embodiment, a fencing optimization may be implemented so as to not issue fences initially. In such an optimistic approach, fences may, in some cases, only be inserted after a capacity overrun for a specific speculative region is determined. If such detection is made, a switch to a pessimist mode may be implemented, where fences are actually generated, in accordance with one or more embodiments described herein. This switch may occur inside the processing device (e.g., GPU 125 and/or CPU 140), in a manner transparent to the application running on the processing device, by employing a prediction mechanism similar to branch prediction. This prediction scheme may predict if a particular ASF speculative region relies on additional fences in order to deliver a guarantee. If the prediction indicates that additional fences may be needed, the switch may occur to the more pessimistic fence insertion scheme. An alternative approach may include static execution of the attempt following a capacity abort in the pessimistic mode. In such an alternative approach, a CPU (e.g., 140) may not need to manage additional states and prediction schemes may not be needed.

It should be noted that various portions of the CPU 140 pipeline, as would be known to a person of ordinary skill in the art having the benefit of this disclosure and not shown, may be included in different embodiments herein. For example, one or more scheduling stages (not shown) may be included in the pipeline. Such additional pipeline portions are excluded from the Figures for the sake of clarity, although it is contemplated that the embodiments described herein may be realized including such additional pipeline portions.

Referring now to FIGS. 4-6, in one or more embodiments the compiler 410 fencing approach and the processor (e.g., GPU 125 and/or CPU 140) approach may be combined and used concurrently. In such a combination, for example, the compiler 410 may generate fences for one or more portions of source code 430 that can be analyzed statically, and the CPU 140 may generate fences for portions of the instruction stream that do not have enough fences to provide the hardware capacity guarantee.

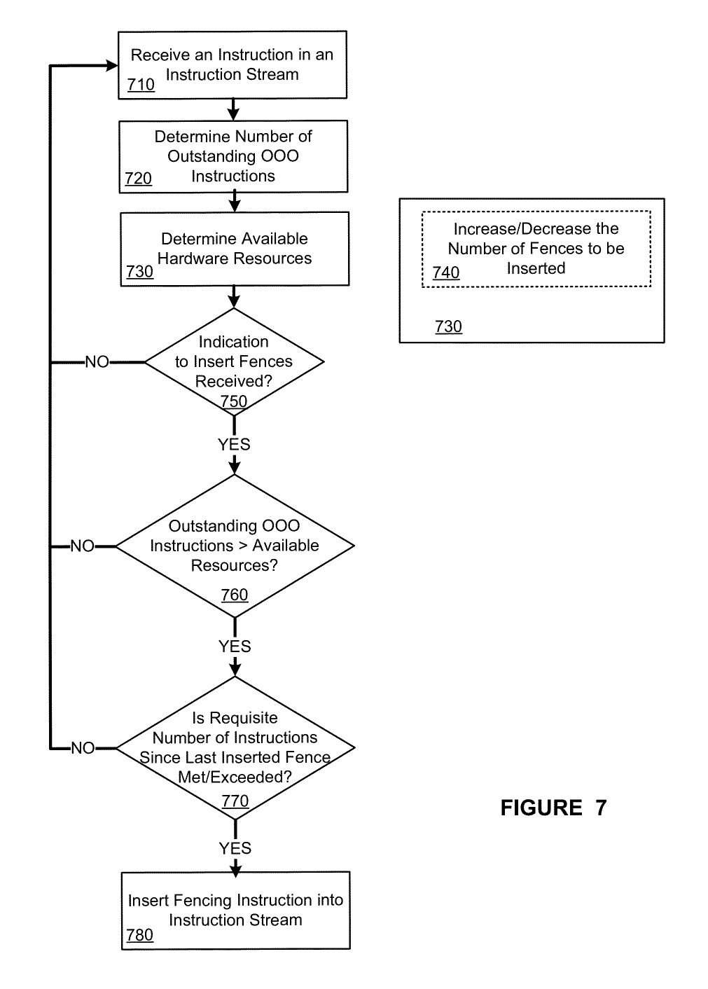

Turning now to FIG. 7, a flowchart depicting managing of hardware guarantees using fences is shown, in accordance with one or more embodiments. At 710, an instruction in an instruction stream may be received. In one embodiment, the instruction may be received at a processing device such as GPU 125 and/or CPU 140. At 720, the number of outstanding OOO speculation instructions may be determined. At 730, a determination may be made as to the available hardware capacity associated with the processing device. In some embodiments, the flow may proceed to 740 where the number of fences to insert per instruction in the instruction stream may be determined. For example, fences may be inserted into the instruction stream every two, four, eight, twelve, or other number of instructions. In other words, fences may be inserted into the instruction stream at a determined interval. At 750, it may be determined if an indication to insert instructions in the instruction stream has been received. If such an indication has not been received, the flow may return to 710. If such an indication has been received, the flow may proceed to 760 where it is determined if the number of outstanding OOO instructions exceeds the available hardware resource capacity. In some embodiments, the determination may be if the number of outstanding OOO instructions is greater than or equal to the available hardware resource capacity. If not, the flow may return to 710. If so, then flow may proceed to 770 for a determination of whether the requisite number of instructions has been issued since the last inserted fence has been met or exceeded. If not, the flow may return to 710. If so, the flow may proceed to 780 where a fencing instruction may be inserted into the instruction stream, in accordance with one or more embodiments described herein. After 780, the flow may proceed to 710 (not shown), and the flow may be repeated.

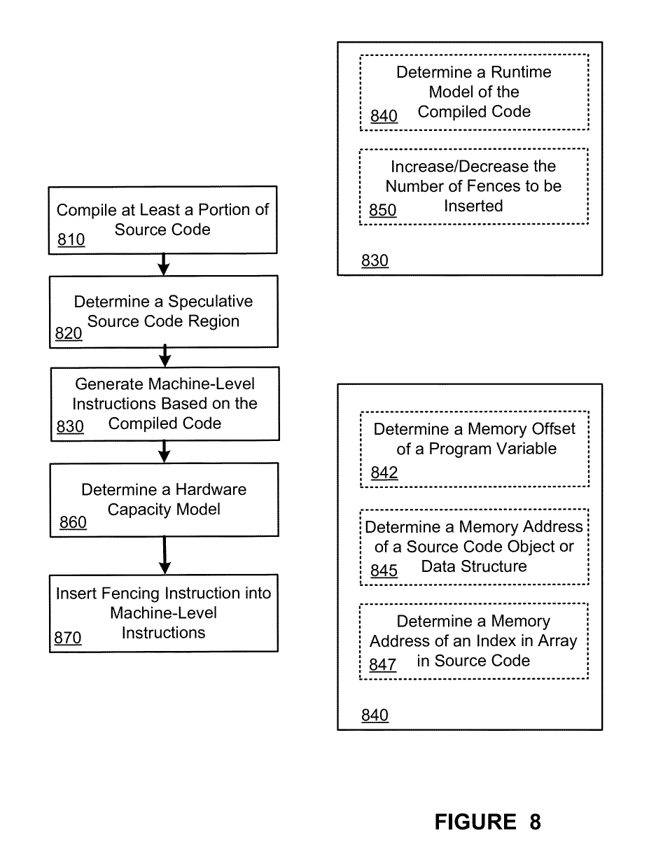

Turning now to FIG. 8, a flowchart depicting managing of hardware guarantees using fences is shown, in accordance with one or more embodiments. At 810, at least a portion of source code is compiled. In accordance one or more embodiments, the source code may be source code 430 and the code may be compiled by a compiler 410. At 820, a speculative source code region may be determined. At 830, binary instructions (machine-level instructions) may be generated from the compiled code. In one embodiment, the element 830 may include determining a runtime model of the compiled code (840) and/or increasing or decreasing the number of fencing instructions to be inserted in the binary instructions (850), in accordance with one or more embodiments described herein. Additionally, in one or more embodiments, the element 840 may include determining a memory offset of a program variable (842), determining a memory address of an object or data structure (845), and/or determining a memory address of an array index (e.g., an index of an array of variables). From 830, the flow may proceed to 860 where a hardware capacity model may be determined, in accordance with one or more embodiments described herein. For example, a compiler (e.g., the compiler 410) may be able to map/determine memory distribution and/or usage (e.g., usage over cache-lines) with respect to variables of a program in order to insert fencing instructions at desired and/or necessary points in the machine-level instructions to maintain a given level of hardware guarantee(s). A transactional and/or run-time model may thus be determined and/or used by the compiler. At 870, a fencing instruction may be inserted into the generated binary instructions. After 870, the flow may proceed to 810 (not shown), and the flow may be repeated.

It is contemplated that the elements as shown in FIGS. 7 and/or 8 are not limited to the order in which they are described above. In accordance with one or more embodiments, the elements shown in FIGS. 7 and/or 8 may be performed sequentially, in parallel, or in alternate order(s) without departing from the spirit and scope of the embodiments presented herein. It is also contemplated that the flowcharts may be performed in whole, or in part(s), in accordance with one or more embodiments presented herein. That is, the flowcharts shown in the Figures need not perform every element described in one or more embodiments.

It is also contemplated that, in some embodiments, different kinds of hardware descriptive languages (HDL) may be used in the process of designing and manufacturing very large scale integration circuits (VLSI circuits) such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units 160, RAMs 155 (including embedded RAMs, SRAMs and/or DRAMs), compact discs, DVDs, solid state storage and/or the like). In one embodiment, the GDSII data (or other similar data) may be adapted to configure a manufacturing facility (e.g., through the use of mask works) to create devices capable of embodying various aspects described herein, in the instant application. In other words, in various embodiments, this GDSII data (or other similar data) may be programmed into a computer 100, processor 125/140 or controller, which may then control, in whole or part, the operation of a semiconductor manufacturing facility (or fab) to create semiconductor products and devices. For example, in one embodiment, silicon wafers containing one or more CPUs 140/GPUs 125 and/or caches 130, that may contain fence generating circuitry and/or OOO speculation monitoring circuitry, and/or the like may be created using the GDSII data (or other similar data).

It should also be noted that while various embodiments may be described in terms of CPUs and/or GPUs, it is contemplated that the embodiments described herein may have a wide range of applicability, for example, in hardware-transactional-memory (HTM) systems in general, as would be apparent to one of skill in the art having the benefit of this disclosure. For example, the embodiments described herein may be used in HTM hardware capacity guarantee management for CPUs, GPUs, APUs, chipsets and/or the like.

The particular embodiments disclosed above are illustrative only, as the embodiments herein may be modified and practiced in different but equivalent manners apparent to those skilled in the art having the benefit of the teachings herein. Furthermore, no limitations are intended to the details of construction or design as shown herein, other than as described in the claims below. It is therefore evident that the particular embodiments disclosed above may be altered or modified and all such variations are considered within the scope of the claimed invention.

Accordingly, the protection sought herein is as set forth in the claims below.

What is claimed:

1. A method, comprising:
determining a number of outstanding out-of-order instructions in an instruction stream to be executed by a processing device;
determining a number of hardware resources available for executing out-of-order instructions; and
inserting at least one fencing instruction into the instruction stream in response to determining the number of outstanding out-of-order instructions exceeds the determined number of available hardware resources.

2. The method of claim 1, wherein the at least one fencing instruction is at least one of a dedicated fencing micro-instruction or a non-fencing micro-instruction modified to comprise a fencing indication.

3. The method of claim 1, wherein inserting at least one fencing instruction comprises inserting a plurality of fencing instructions into the instruction stream at a determined interval.

4. The method of claim 1, further comprising:
determining a decrease in the number of available hardware resources; and
increasing a number of fencing instructions inserted per number of instructions in the instruction stream in response to the determined decrease of in the number of available hardware resources.

5. The method of claim 1, further comprising:
determining an increase in the number of available hardware resources; and
decreasing a number of fencing instructions inserted per number of instructions in the instruction stream in response to the determined increase in the number of available of hardware resources.

6. The method of claim 1, further comprising at least one of:
wherein the at least one fencing instruction is inserted into the instruction stream at a decoding stage; and
wherein the at least one fencing instruction is inserted into the instruction stream at a pipelining stage.

7. The method of claim 1, wherein inserting the fencing instruction into the instruction stream comprises:
receiving an indication to include fencing instructions in the instruction stream; and
inserting the at least one fencing instruction in response to the received indication.

8. The method of claim 1, further comprising:
compiling a portion of source code;
generating a plurality of machine-level instructions based at least on the portion of source code; and
inserting at least one fencing instruction into the plurality of machine-level instructions in response to determining a speculative region in the portion of source code.

9. A method, comprising:
compiling a portion of source code, comprising:
determining a speculative region associated with the portion of source code;
generating a plurality of machine-level instructions based at least on the portion of source code; and
inserting at least one fencing instruction into the plurality of machine-level instructions in response to determining the speculative region.

10. The method of claim 9, wherein the fencing instruction is at least one of a dedicated fencing machine-level instruction or a non-fencing machine-level instruction modified to comprise a fencing indication.

11. The method of claim 9, wherein inserting the at least one fencing instruction comprises inserting a plurality of fencing instructions into the plurality of machine-level instructions at a determined interval.

12. The method of claim 9, further comprising:
determining a runtime model of the plurality of machine-level instructions; and
wherein inserting the at least one fencing instruction into the plurality of machine-level instructions is based at least upon the determined runtime model.

13. The method of claim 12, further comprising at least one of:
decreasing the number of fencing instructions inserted in response to a model-based indication of available hardware capacity; and
increasing the number of fencing instructions inserted in response to the model-based indication of available hardware capacity.

14. The method of claim 12, wherein the runtime model comprises at least one of:
determining a memory access address offset of at least one variable in the portion of source code;
determining a memory access address of at least one object or data structure; and
determining at least one memory access address of one or more indices in an array of variables.

15. The method of claim 9, further comprising:
defining a hardware capacity model associated with a micro-processor architecture based at least upon a performance characteristic;
inserting the at least one fencing instruction based upon the hardware capacity model; and
increasing the number of fencing instructions inserted in response to a runtime determination of a decrease in available hardware capacity.

16. The method of claim 9, further comprising:
determining a number of available hardware resources associated with a processing device; and
inserting at least one fencing instruction into an instruction stream associated with the processing device in response to determining the number available hardware resources.

17. A processing device that comprises:
at least one cache memory;
at least one processing unit, communicatively coupled to the at least one cache memory, being adapted to execute one or more processing device instructions in an instruction stream; and
an out-of-order speculation supervisor unit adapted to determine an availability of at least one hardware resource associated with the processing device, and adapted to generate an indication to insert a fencing instruction in response to the determined availability.

18. The processing device of claim 17, further comprising:
a decode unit communicatively coupled to the at least one processing unit and to the out-of-order speculation supervisor unit; and
wherein the decode unit is adapted to receive the fencing indication from the out-of-order speculation supervisor unit and adapted to insert a fencing instruction into the instruction stream.

19. The processing device of claim 17, further comprising:
an instruction pipeline unit communicatively coupled to the at least one processing unit and to the out-of-order speculation supervisor unit; and
wherein the instruction pipeline unit includes an issue stage adapted to receive an inserted fencing instruction based at least upon the fencing indication.

20. A non-transitory, computer-readable storage device encoded with data that, when implemented in a manufacturing facility, adapts the manufacturing facility to create an apparatus, wherein the apparatus comprises:
at least one cache memory;
at least one processing unit, communicatively coupled to the at least one cache memory, being adapted to execute one or more processing device instructions in an instruction stream; and
an out-of-order speculation supervisor unit adapted to determine an availability of at least one hardware resource associated with the processing device, and adapted to generate an indication to insert a fencing instruction in response to the determined availability.

21. The non-transitory, computer-readable storage device encoded with data that, when implemented in a manufacturing facility, adapts the manufacturing facility to create an apparatus as in claim 20, wherein the apparatus further comprises:
a decode unit communicatively coupled to the at least one processing unit and to the out-of-order speculation supervisor unit; and
wherein the decode unit is adapted to receive the fencing indication from the out-of-order speculation supervisor unit and adapted to insert a fencing instruction into the instruction stream.

22. The non-transitory, computer-readable storage device encoded with data that, when implemented in a manufacturing facility, adapts the manufacturing facility to create an apparatus as in claim 20, wherein the apparatus further comprises:
an instruction pipeline unit communicatively coupled to the at least one processing unit and to the out-of-order speculation supervisor unit; and
wherein the instruction pipeline unit includes an issue stage adapted to receive an inserted fencing instruction based at least upon the fencing indication.

23. A non-transitory, computer-readable storage device encoded with data that, when executed by a processing device, adapts the processing device to perform a method, comprising:
determining a number of outstanding out-of-order instructions in an instruction stream to be executed by a processing device;
determining a number of hardware resources available for executing out-of-order instructions; and
inserting at least one fencing instruction into the instruction stream in response to determining the number of outstanding out-of-order instructions exceeds the determined number of available hardware resources.

24. A non-transitory, computer-readable storage device encoded with data that, when executed by a processing device, adapts the processing device to perform a method, comprising:
compiling a portion of source code, comprising:
determining a speculative region associated with the portion of source code;
generating a plurality of machine-level instructions based at least on the portion of source code; and
inserting at least one fencing instruction into the plurality of machine-level instructions in response to determining the speculative region.
